(19) United States
(12) Patent Application Publication
(10) Pub. No.: US 2025/0187413 A1
(43) Pub. Date: Jun. 12, 2025

(54) HARDTOP AND HARDTOP SHELL FOR VEHICLE INSTALLATION

(71) Applicant: Armadillo Designs, Inc., Bellville, TX (US)

(72) Inventors: Samuel Hunt, Santa Rosa, CA (US); Fabian Araujo, Los Osos, CA (US); Jonathan Parrella, Bellville, TX (US); Daniel Parrella, Bellville, TX (US); Michael Cammack, Bellville, TX (US)

(21) Appl. No.: 18/979,455

(22) Filed: Dec. 12, 2024

Related U.S. Application Data
(60) Provisional application No. 63/609,311, filed on Dec. 12, 2023.

(51) Int. Cl. B60J 7/16; B60J 10/90; B60R 9/058; B60R 11/00; B62D 29/00

(52) U.S. Cl. CPC B60J 7/165; B60J 7/1642; B60J 10/90; B60R 9/058; B60R 11/00; B62D 29/008; B60R 2011/004

(57) ABSTRACT

A hardtop shell is provided for vehicles having a variety of vehicle body styles, including all sport utility vehicles (SUV), trucks and crossovers. The hardtop shell follows the top frame of the vehicle/OEM roll cage, allowing for much more open-air space, when removing modular portions of the hardtop. The hardtop shell follows the top frame of the vehicle. The hardtop shell also can be mainly fabricated out of metal. The hardtop shell comprises a main outer frame that mates to the body and frame of the vehicle, and may also comprise modular and removable additional components such as roof panels, a rear door and gull wings. The main frame mates to the body or frame of the vehicle with a plurality of bolts, nuts, rivnuts, gaskets, seals, compression latches and other similar hardware or methods.

### CROSS-REFERENCE TO RELATED APPLICATIONS

The present application claims the benefit of U.S. Provisional Application No. 63/609,311, filed Dec. 12, 2023, which is incorporated by reference in its entirety.

### BACKGROUND OF THE DISCLOSURE

Certain styles of vehicles, such as sport utility vehicles (SUVs), trucks, and crossovers, often have a need for a hardtop cover for the top and rear of the vehicle, which can be added on or permanently affixed, to cover open portions or to replace soft covers on the vehicle.

However, there are many problems with hardtops in the state of the art, as they often lack the ability to securely be affixed and sealed to the vehicle and allow for modular accessories to be mounted thereon in a simple manner and without impacting the vehicle negatively. The present application seeks to address these shortcomings in the art.

### SUMMARY OF THE DISCLOSURE

The present application relates to a permanent install hardtop shell for vehicles having a variety of vehicle body styles, including all SUVs, trucks and crossovers. The hardtop shell follows the top frame of the vehicle/OEM roll cage, allowing for much more open-air space, when removing modular portions of the hardtop. The hardtop follows the top frame of the vehicle. The hardtop also can be mainly fabricated out of metal. The hardtop comprises a main outer frame that mates to the body and frame of the vehicle, and may also comprise modular and removable additional components such as roof panels, a rear door and/or gull wings. The main frame mates to the body or frame of the vehicle with a plurality of bolts, nuts, rivnuts, gaskets, seals, compression latches and other similar hardware or methods.

The hardtop can be driven with or without any combination of the additional components and can also support additional rooftop attachments secured or bolted directly to the hardtop.

### BRIEF DESCRIPTION OF THE FIGURES

FIGS. 1A-1C show front upper perspective, rear side perspective, and lower rear perspective views, respectively, of a hardtop according to the present application;

FIG. 2A-2C show front upper perspective, rear side perspective, and lower rear perspective views, respectively, of the hardtop with accessories according to the present application;

FIGS. 3A-3C show mounting and sealing locations for modular attachments or accessories for the hardtop according to the present application;

FIG. 4 shows various views of a top roof rack installation on the hardtops of the present application;

FIG. 5 shows various views of a top roof rack installation on the hardtops of the present application; and

FIGS. 6A-6D shows examples of a vehicle having the hardtop of the present application thereon.

### DETAILED DESCRIPTION OF THE FIGURES

The present application relates to a permanent install hardtop shell 10 for vehicles having a variety of vehicle body styles, including all sport utility vehicles (SUV), trucks and crossovers.

The hardtop shell 10 follows the top frame of the vehicle/OEM roll cage, allowing for much more open-air space, when removing modular portions of the hardtop. The hardtop shell 10 follows the top frame of the vehicle. The hardtop shell 10 also can be mainly fabricated out of metal. The hardtop shell 10 comprises a main outer frame 11 that mates to the body and frame of the vehicle, and may also comprise modular and removable additional components such as roof panels, a rear door and gull wings. The main frame 11 mates to the body or frame of the vehicle with a plurality of bolts, nuts, rivnuts, gaskets, seals, compression latches and other similar hardware or methods.

A vehicle with the hardtop shell 10 can be driven with or without any combination of the additional components and can also support additional rooftop attachments secured or bolted directly to the hardtop shell 10.

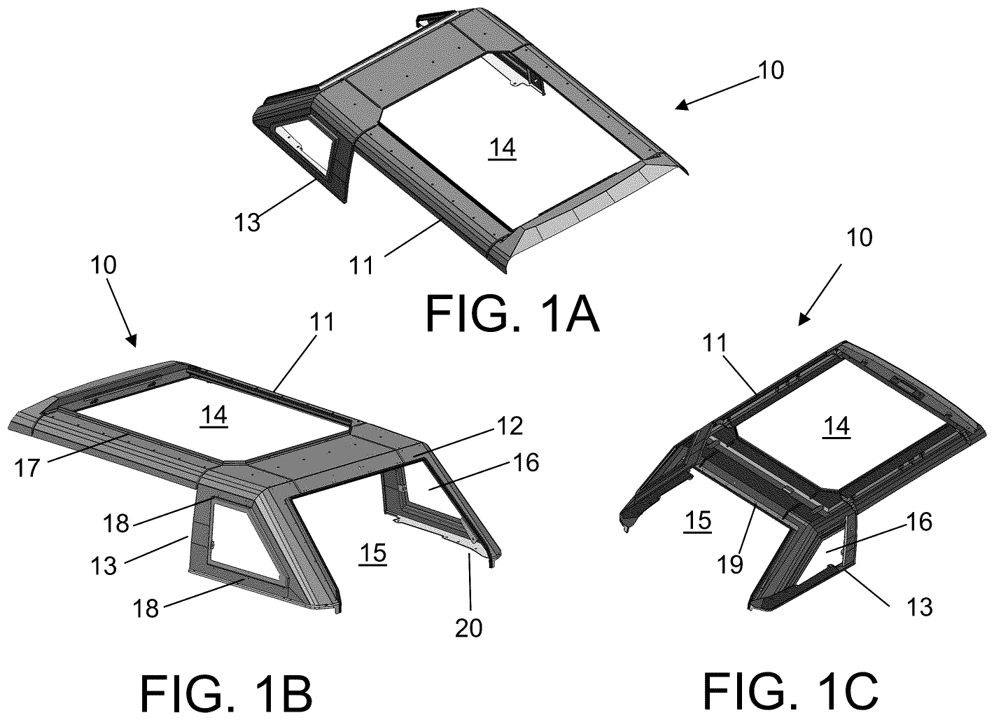

FIG. 1 shows a first example of a hardtop shell 10 according to the present application. The hardtop shell 10 in this example is created from 5052 aluminum that is cut, bent and welded into shape. Other metals or suitable materials may be used in other embodiments of the hardtop shell 10. The main frame 11 serves as an upper section of the hardtop shell 10 and is supported and mounted to an upper frame of the vehicle. This main frame 11 of the hardtop shell 10 seals against the main body and frame of the vehicle, and may require more effort to remove than the accessories added to the hardtop shell 10, making it more convenient to leave affixed to the vehicle at all times. Additional mounts 20 may be provided at the base of the hardtop shell 10, to mount the hardtop shell 10 to the vehicle in additional or alternative locations.

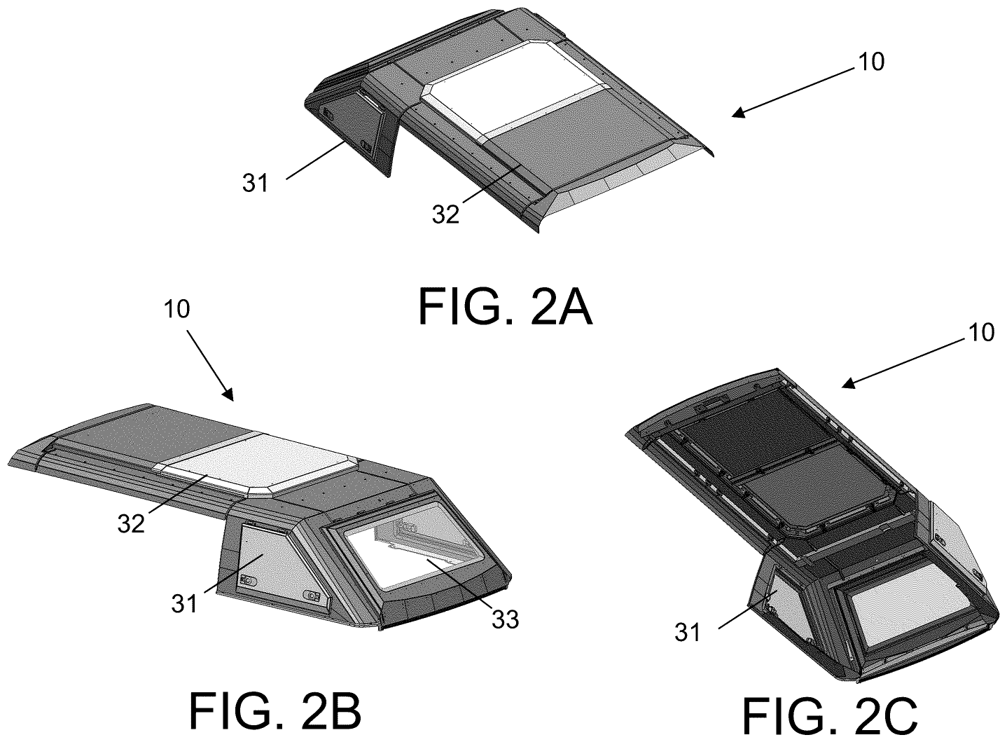

In addition to the upper section 11, the hardtop shell 10 also comprises a rear section 12, and two side sections 13. Each section 11, 12, 13 includes an opening therethrough, including an upper opening 14, a rear opening 15, and a side opening 16. Each section 11, 12, 13 also includes one or more mounts, including top mounts 17, rear mounts 18, and side mounts 19, such as bolt holes, which can be configured to mount accessories such as gull wings 31, panels 32, windows 33, or doors, as shown in FIGS. 2A-2C.

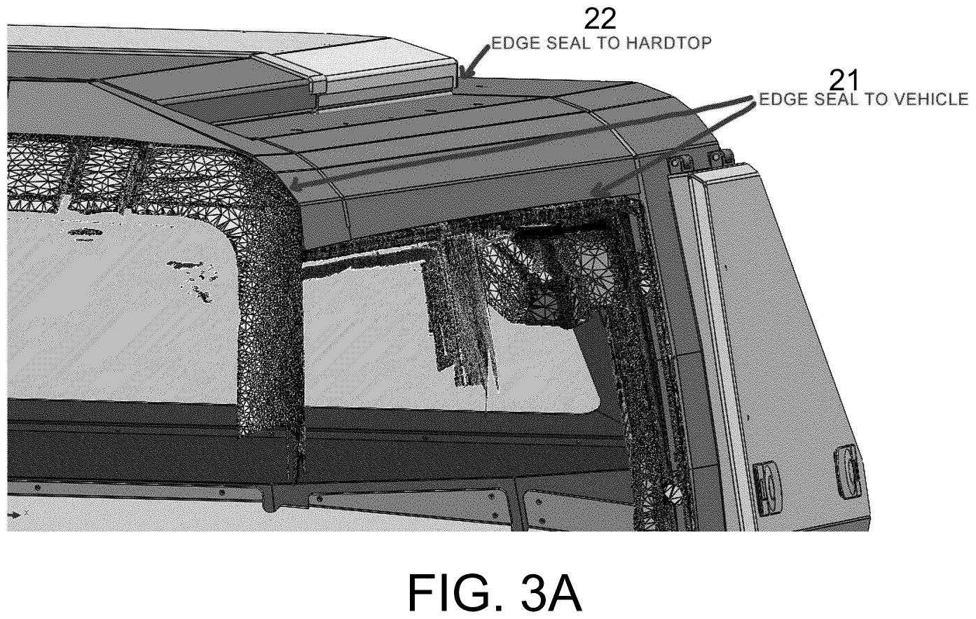

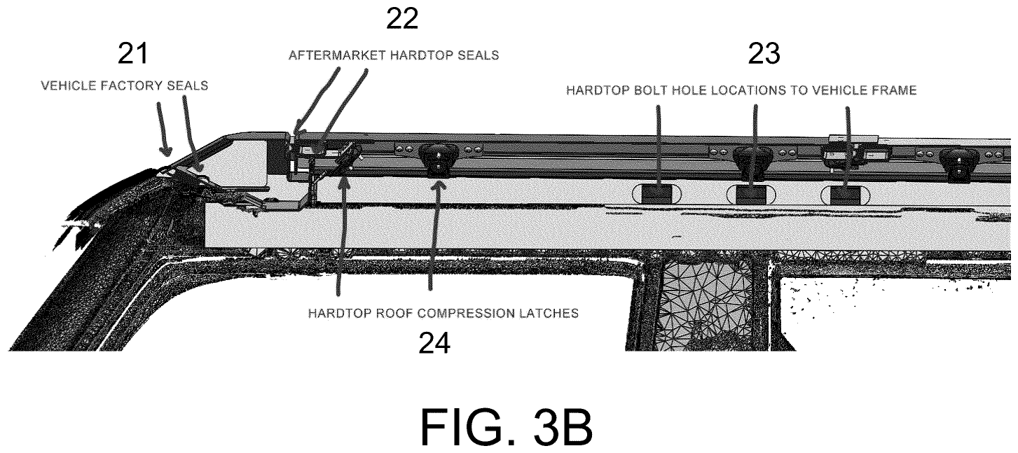

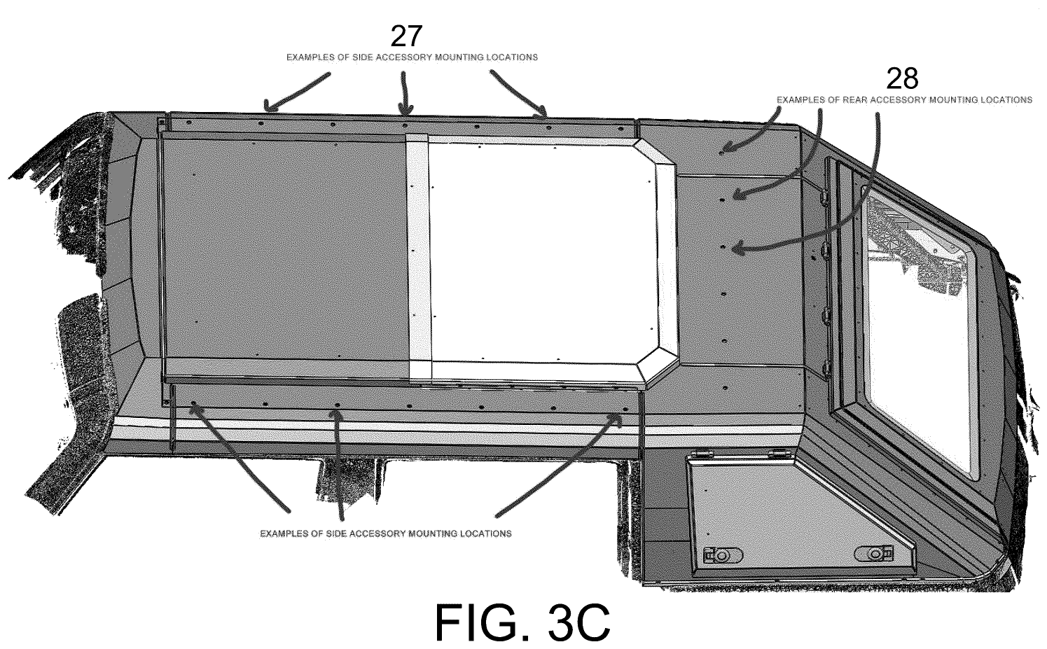

The frame of the hardtop shell 10 provides for repeatable mounting and sealing locations for the modular attachments and accessories for the hardtop shell 10 and vehicle, some examples of which are shown in FIGS. 3A-3C. This allows users to remove accessories, such as the roof panels simply by unbolting, unlatching, unlocking or any method similar. With any combination of the attachments removed, the main frame and structure of the hardtop can remain more permanently installed and in service.

FIG. 3A illustrates sealing locations for the hardtop, which includes edge seals 21 to the vehicle from the hardtop shell 10, and edge seals to the hardtop shell 10.

FIG. 3B illustrates a side cross-sectional view of a hardtop shell 10 secured to the vehicle. A plurality of bolt holes 23 are provided on the upper section 11 of the hardtop shell 10, through which bolts are inserted and attached to securely affix the hardtop shell 10 to the vehicle frame. A plurality of compression latches 26 may also be provide to further secure and seal the hardtop shell 10 to the vehicle. Vehicle seals 21, between the hardtop shell 10 and vehicle frame, and hardtop seals 22 around the opening 14 and between the panel 32 (or other accessory) and the hardtop frame 11 are also shown in FIG. 3B.

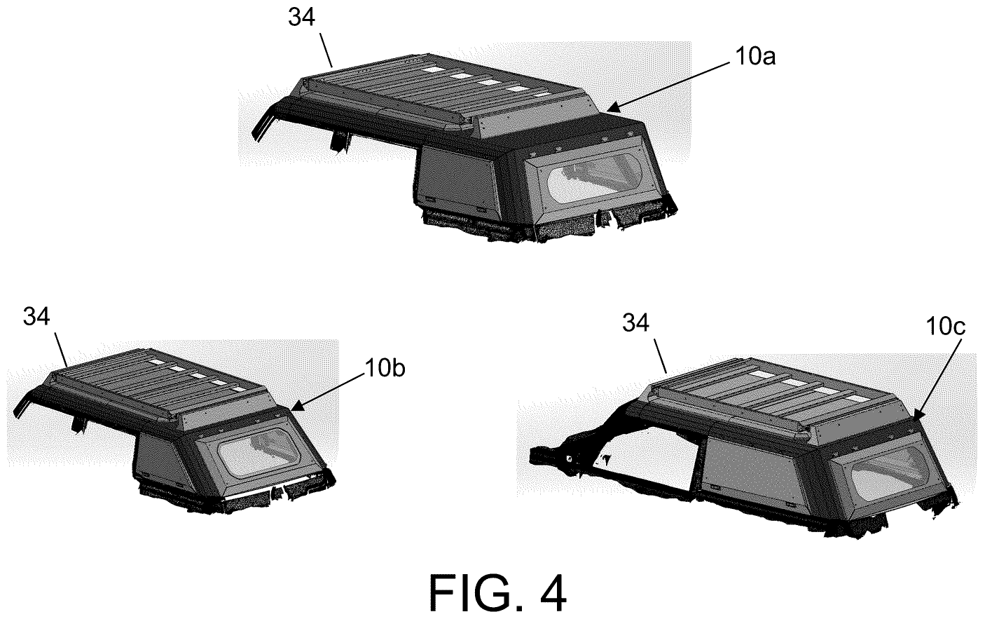

The upper section 11 of the hardtop shell 10 also comprises a plurality of mounting locations for external accessories for the vehicle, shown in FIG. 3C. The hardtop shell 10 may comprise side accessory mounting locations 27 and rear accessory mounting locations 28. The accessory mounting locations may include bolt or screw holes configured to attach accessories to the hardtop shell 10, such as a roof rack 34, shown for example in FIG. 4. The hardtop shell 10 may have additional accessory bolt holes and mounting points located on the hardtop's exterior and interior not shown in the Figures. The modularity of the hardtop shell 10 allows users to install accessories without needing to further modify the vehicle or hardtop. The hardtop shell 10 is future accessory ready. One should not have to drill holes in the vehicle or hardtop, as a result of these bolt holes located for future accessories in mind.

FIG. 4 shows a roof rack 34 installed on three different models of the hardtop shell 10a, 10b, 10c, each of which illustrates a different configuration or shape of the hardtop shell 10. As shown in the Figure, the hardtop shell 10 may take different forms, including for example the rear and side sections 12, 13 and their openings 15, 16 having different shapes or dimensions in different versions of the hardtop shell 10.

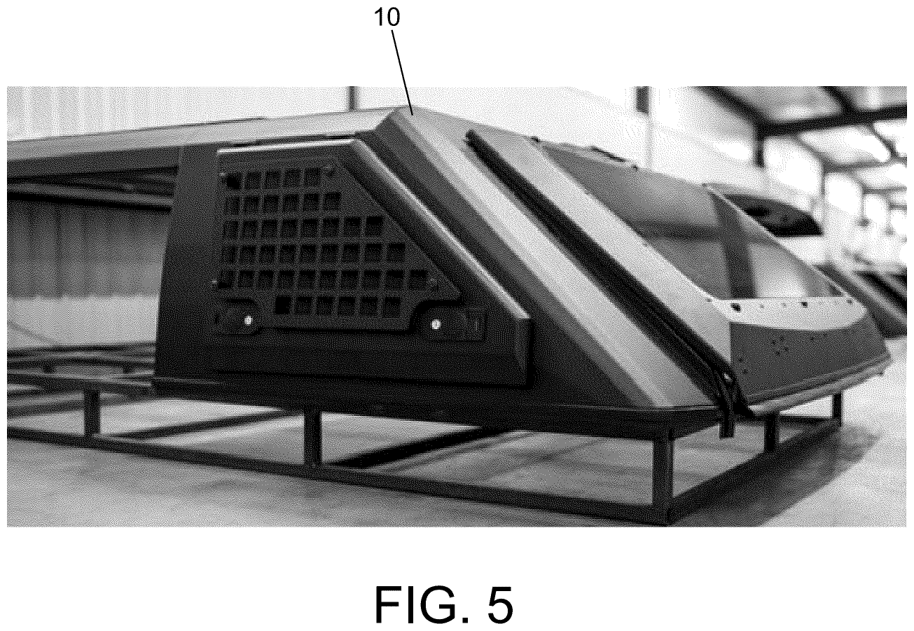

FIG. 5 shows a further view of a hardtop shell 10 having accessories mounted on the side section 13 and rear section 12.

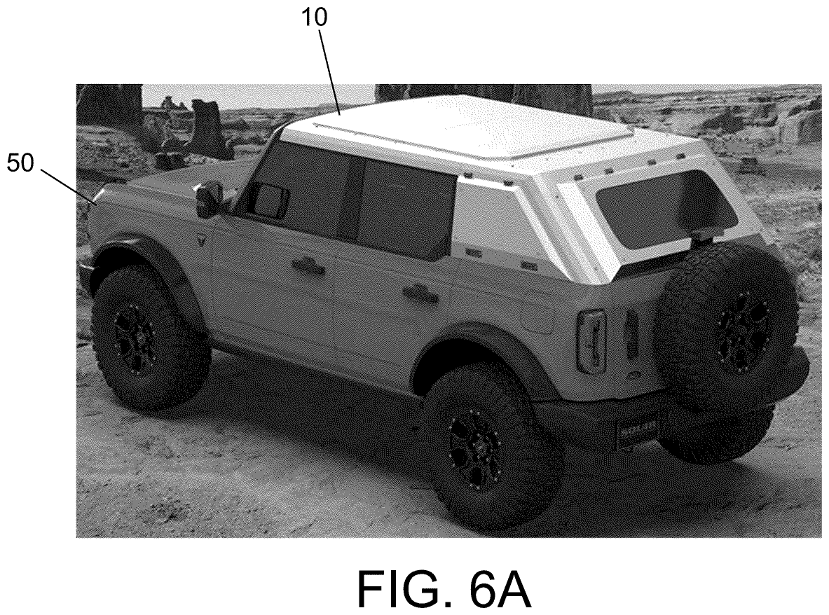

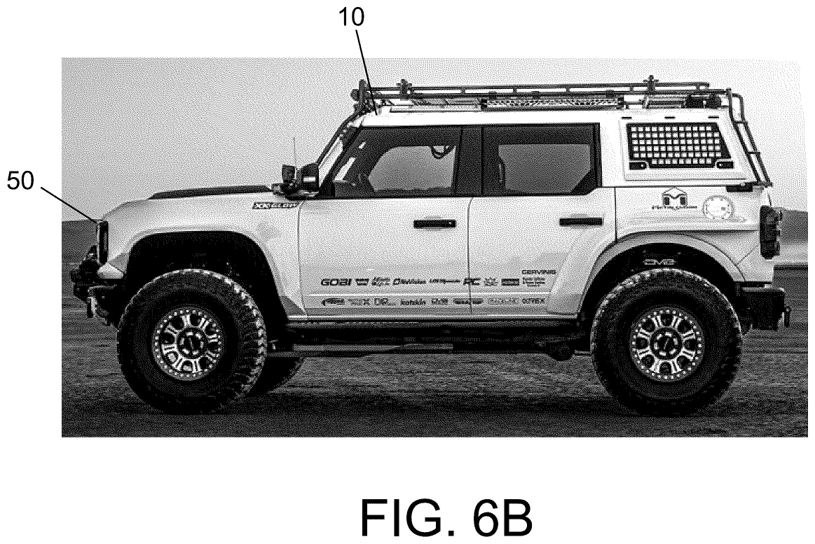

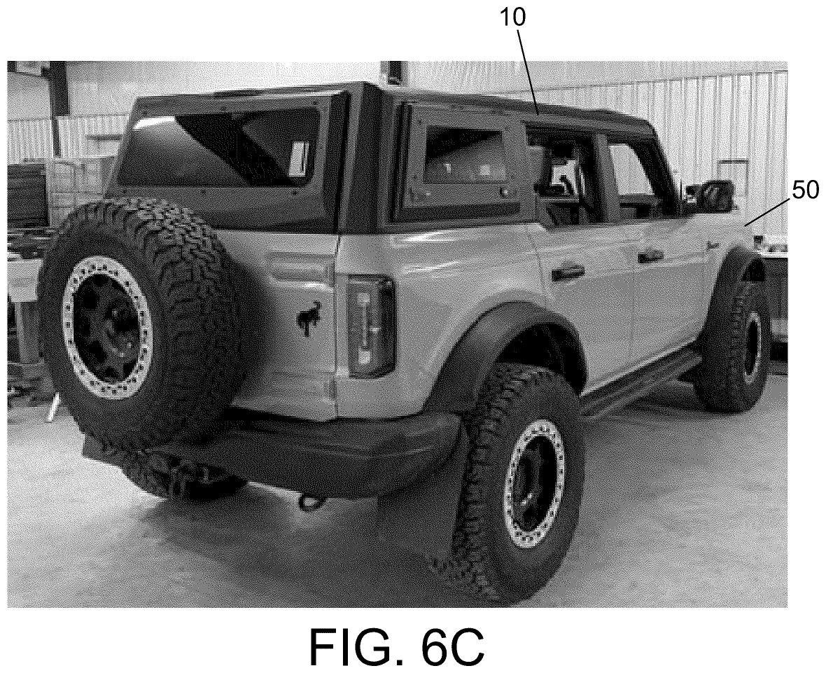

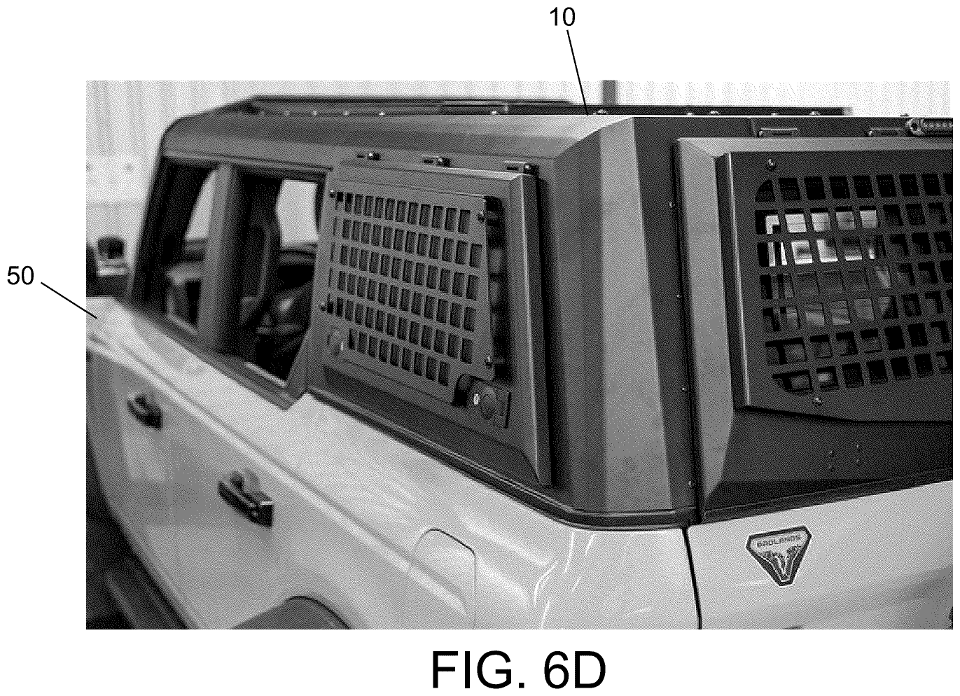

FIGS. 6A-6D shows various examples of vehicles 50 having the hardtop shell 10 of the present application thereon.

While there have been shown and described and pointed out fundamental novel features of the invention as applied to embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed:

1. A hardtop shell for a vehicle, comprising:
an upper frame section comprising:
a plurality of upper vehicle mounts configured to mount the hardtop shell to the top of a vehicle; and
one or more upper accessory mounts;
a rear section; and
a pair of side sections, each adjacent to the rear section.

2. The hardtop shell of claim 1, wherein the upper frame section comprises a central opening therethrough.

3. The hardtop shell of claim 2, wherein the upper frame section comprises a further plurality of hardtop accessory mounts configured to mount an accessory over the opening of upper frame section.

4. The hardtop shell of claim 1, wherein the rear section comprises one or more rear accessory mounts.

5. The hardtop shell of claim 1, wherein the rear section comprises a central opening therethrough.

6. The hardtop shell of claim 2, wherein the side sections each comprise one or more side accessory mounts.

7. The hardtop shell of claim 2, wherein the side sections each comprise one or more side accessory mounts.

8. The hardtop shell of claim 1, wherein the upper frame section comprises one or more seals around edges of the upper frame section configured to abut the top of the vehicle.

9. The hardtop shell of claim 3, wherein the upper frame section comprises one or more seals around the central opening to provide a seal between the accessory and the upper frame section.

10. The hardtop shell of claim 1, wherein the one or more upper accessory mounts comprise a plurality of mounting holes arranged along each longitudinal side of the upper frame section.

11. The hardtop shell of claim 1, wherein the one or more upper accessory mounts comprise a plurality of mounting holes arranged along the rear of the upper frame section, adjacent to the rear section.

12. The hardtop shell of claim 1, further comprising at least one lower vehicle mounts configured to mount the hardtop shell to the vehicle in a separate location than the plurality of upper vehicle mounts.

13. A hardtop for a vehicle, comprising
a hardtop shell comprising:
an upper frame section comprising:
a plurality of upper vehicle mounts configured to mount the hardtop shell to the top of a vehicle; and
one or more upper accessory mounts;
a rear section comprising one or more rear accessory mounts; and
a pair of side sections, each adjacent to the rear section and comprising one or more side accessory mounts; and
at least one accessory mounted to one of the upper frame section, the rear section, or one of the pair of side sections.

14. The hardtop for a vehicle according to claim 13, wherein the at least one accessory comprises one or more of a roof rack, a gull wing, a window, a panel, or a door.

15. The hardtop for a vehicle according to claim 13, wherein the hardtop shell comprises aluminum.
